(19) United States
(12) Patent Application Publication
(10) Pub. No.: US 2009/0152414 A1
(43) Pub. Date: Jun. 18, 2009

(54) Surgical stands, surgical instrument organizer assemblies, and methods of use therefor

(75) Inventor: Diane C. Lyons, Massillon, OH (US)

Correspondence Address: WALKER & JOCKE, L.P.A., 231 SOUTH BROADWAY STREET, MEDINA, OH, 44256, US

(73) Assignee: RWY Acquisition LLC, Medina, OH (US)

(21) Appl. No.: 12/315,839

(22) Filed: Dec. 5, 2008

Related U.S. Application Data
(63) Continuation-in-part of application No. 11/775,311, filed on Jul. 10, 2007, now Pat. No. 7,461,751.
(60) Provisional application No. 61/072,277, filed on Mar. 28, 2008.
(60) Provisional application No. 60/830,435, filed on Jul. 12, 2006.

(51) Int. Cl. F16M 11/20; F16M 11/00; A47F 7/00

(52) U.S. Cl. 248/176.1; 248/127; 211/85.13

(57) ABSTRACT

A surgical instrument stand for supportingly receiving surgical instruments is provided. The instrument stand includes at least one instrument support, a first end plate, and a second end plate. The second end plate is positionally coupled to the first end plate by the at least one instrument support. A surgical instrument organizer assembly for supportingly receiving surgical instruments is provided. The organizer includes the instrument stand and at least one clamp. Each clamp is positionably coupled to the at least one instrument support at a desired axial position thereof. Each clamp is configured to separate one surgical instrument from another surgical instrument. The at least one clamp can hold a surgical instrument in operative engagement with a support in a desired orientation. The arrangement of the surgical instrument stand permits disassembly thereof to facilitate sterilization for reuse.

### CROSS REFERENCE TO RELATED APPLICATIONS

This application claims benefit under 35 U.S.C. §119(e) of U.S. Provisional Application 61/072,277 filed Mar. 28, 2008. This application is also a continuation-in-part of U.S. application Ser. No. 11/775,311 filed Jul. 10, 2007, now U.S. Pat. No. 7,461,751, which claims benefit pursuant to 35 U.S.C. §119(e) of U.S. Provisional Application 60/830,435 filed Jul. 12, 2006. The disclosures of each of these Applications are herein incorporated by reference in their entirety.

### TECHNICAL FIELD

The present invention relates generally to surgical instrument organization systems used in surgical settings to organize surgical instruments for reliable, rapid, ready access by medical personnel as needed during a surgical procedure and, more particularly, to surgical stands, surgical instrument organizer assemblies, and methods of use therefor.

### BACKGROUND OF INVENTION

Surgical instruments anticipated as likely to be needed during any surgical procedure are conventionally assembled in advance of the surgery on a tray by, for example, a surgery technician or nurse. The tray is stably supported, such as along one side thereof, on rollers above the surgery floor in order to allow mobility and accessibility to the surgical instruments. The height of the tray above the surgery floor is such as to permit the tray to be selectively positioned at will over any portion of an occupied surgery bed, within easy reach of medical personnel. The tray, in combination with the support and rollers therefor, is conventionally referred to as a “mayo stand.”

Various types of surgical instruments are routinely loaded onto a mayo stand in preparation for use in surgery. These surgical instruments are generally arranged on the mayo stand in a nesting, parallel relationship with the handles of the surgical instruments in alignment. In many cases, similar types of surgical instruments are grouped together and graded by size. Such a line up of surgical instruments is commonly known or referred to as a “stringer” or “stringer of surgical instruments.” Examples of surgical instruments that would commonly be included in a stringer on a mayo stand include hemostats, tonsils, Haney clamps, and needle holders.

Known systems for organizing stringers on a mayo stand employ rolled cotton towels, foam organizers, and complicated metal structures. While the latter are occasionally capable, in addition, of securing a group of medical instruments together temporarily during sterilization in an autoclave, organization systems that employ towels or foam organizers cannot be so sterilized and are thus not reusable. Even metal organizers frequently lack the type of flexibility that would allow medical personnel in the surgical field to customize the organizer to accommodate various sizes of stringers or to allow the metal organizers to adapt to various compositions of surgical instruments within a stringer.

### OBJECTS OF EXEMPLARY EMBODIMENTS

It is an object of an exemplary embodiment to provide a surgical instrument stand capable of reuse after sterilization that accommodates various sizes of stringers or various compositions of surgical instruments within a stringer.

It is a further object of an exemplary embodiment to provide a surgical stand capable of adjustment to accommodate an assortment of surgical instruments while conserving space.

It is a further object of an exemplary embodiment to provide a reusable surgical stand having adjustable divisible sections for accommodating sets of stringers or stringer having different sized instruments.

It is a further object of an exemplary embodiment to provide a surgical stand capable of being stably repositionable about a mayo stand or other support surface and un-affixed therefrom, in order to provide adaptable adjustability for sectionally supporting surgical instruments thereon.

It is a further object of an exemplary embodiment to provide a surgical stand that includes reusable adjustable dividers for receiving stringers of surgical instruments therebetween, particularly for providing sturdy upright support for the surgical instruments.

Further objects of exemplary embodiments will be made apparent in the following detailed description of exemplary embodiments and the appended claims.

In certain exemplary embodiments, an instrument stand is provided that may be reused after sterilization and advantageously accommodates various sizes of stringers and compositions of surgical instruments. An exemplary instrument stand is capable of adjustment allowing accommodation of an assortment of surgical instruments while efficiently conserving and utilizing space upon a mayo stand or other support surface. Further, the reusable instrument stand includes adjustable or divisible sections for accommodating surgical instruments, stringers of surgical instruments, sets of stringers and stringers having different sized surgical instruments. Further still, the exemplary instrument stand may be stably repositioned about a mayo stand or other supporting surface, allowing adaptable adjustability for sectionally supporting surgical instruments thereon or thereabout. Moreover, the exemplary instrument stand may receive reusable adjustable dividers, such as clamps, for receiving surgical instruments therebetween, while providing sturdy upright support for the surgical instruments.

In certain exemplary embodiments, an instrument stand for supportingly receiving surgical instruments is provided. The instrument stand includes at least one of an instrument support and a stabilization support, a first stand section and a second stand section. The second stand section is positionally coupled to the first stand section by at least one of the instrument support and the stabilization support.

In certain exemplary embodiments, a surgical instrument organizer assembly for supportingly receiving surgical instruments is provided. The surgical instrument organizer assembly includes an instrument stand and at least one clamp positionably coupled to the instrument stand.

A method of using a surgical instrument organizer assembly is also provided in accordance with an exemplary embodiment.

Other advantages and features of exemplary embodiments will become apparent when viewed in light of the following detailed description, the attached drawings and appended claims.

### BRIEF DESCRIPTION OF DRAWINGS

FIG. 1 is a perspective view of a surgical facility including a mayo stand positioned over the foot of a surgery bed and loaded with surgical instruments in a stringer arrangement that are thus upheld for ready access by an exemplary embodiment of a surgical instrument organizer assembly.

FIG. 2 is an enlarged perspective view of the exemplary surgical instrument organizer assembly of FIG. 1 without surgical instruments supported thereon.

FIG. 3 is a cross-sectional elevation view of the surgical instrument organizer assembly of FIG. 2 taken along section line 3-3 shown therein.

FIG. 4 is a cross-sectional elevation view an instrument stand of the surgical instrument organizer assembly of FIG. 3 taken along section line 4-4 shown therein.

FIG. 5 shows an assembly view of an instrument stand and exemplary clamp of the surgical instrument organization system of FIG. 2.

FIG. 6 is an isometric view of an alternative embodiment of a surgical instrument stand.

FIG. 7 is an isometric view of a surgical instrument stand similar to that shown in FIG. 6 but with the footings moved further apart to provide a longer instrument support.

FIG. 8 is a side view of an exemplary surgical instrument support supporting a surgical instrument shown in phantom.

FIG. 9 is a cross-sectional view of a member which is included as a part of the support.

FIG. 10 is a cross-sectional view of a further member which is included in the exemplary support.

FIG. 11 is a side view of an arm of an exemplary clamp of an alternative embodiment.

FIG. 12 is a front right isometric view of the clamp arm shown in FIG. 11.

FIG. 13 is a back left isometric view of the exemplary clamp arm shown in FIG. 11.

FIG. 14 is a side view of an alternative form of a clamp engaged with the member shown in FIG. 10.

FIG. 15 is an enlarged view showing the engagement of the clamp shown in FIG. 14 and the member.

FIG. 16 is a side view of the exemplary alternative clamp engaged with the member of FIG. 9.

FIG. 17 is an enlarged view showing engagement of the jaw of the alternative clamp and the member.

FIG. 18 is an isometric view showing the instrument stand operatively supporting five stringers of surgical instruments with the stringers being separated by clamps and engaged with a stringer rod.

FIG. 19 is an isometric view showing an instrument stand and stringers similar to FIG. 18 being positioned on a sterile supporting surface with the stringer rod being disengaged 10 therefrom so as to enable removal of each of the instruments.

FIG. 20 is an isometric view of the alternative instrument stand with the clamps positioned to support an alternative type of surgical instrument therebetween.

FIG. 21 is an isometric view showing the alternative instrument stand supporting a plurality of surgical instruments in a generally upright condition.

### DETAILED DESCRIPTION OF EXEMPLARY EMBODIMENTS

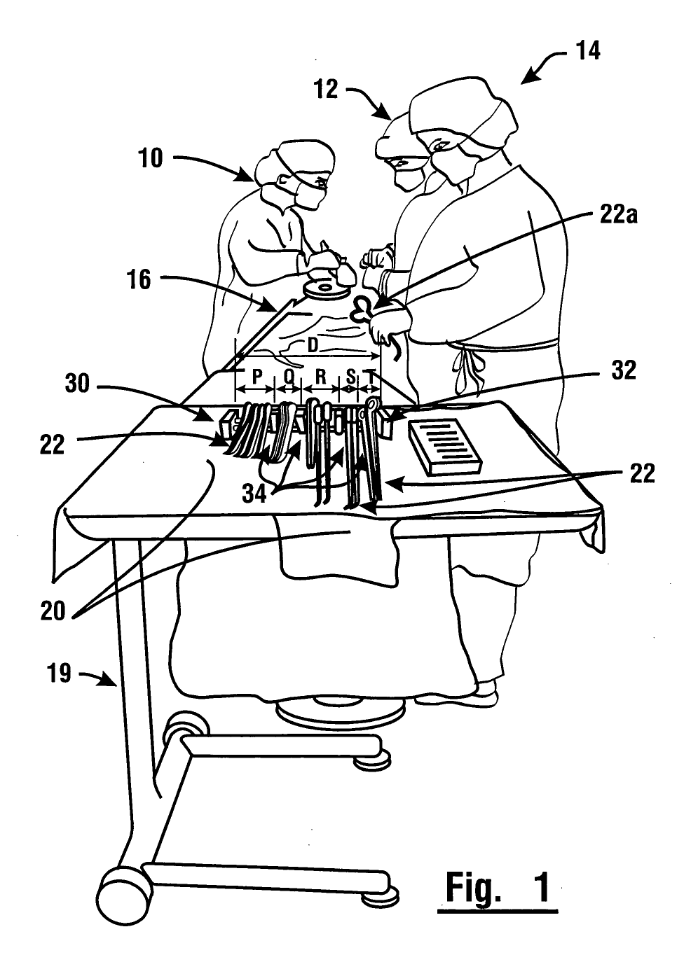

FIG. 1 illustrates an exemplary surgical setting within a surgical facility in which an exemplary surgical instrument organization system, or surgical instrument organizer assembly, 30 may be used. Shown is a doctor 10, a first assistant 12, and a nurse 14 grouped about a surgical table upon which a prone patient 16 is undergoing a surgical procedure. Positioned over the surgical table at the foot of the patient 16 is a mayo stand 18 upon which a stringer 20 arrangement of surgical instruments 22 are organized upon the exemplary surgical instrument organizer assembly 30 and positionally upheld for ready use. The nurse 14 is shown in the process of removing a surgical instrument 22a from the surgical instrument organizer assembly and passing the instrument 22a to the assistant 12.

The exemplary surgical instrument organizer assembly 30 includes an instrument stand 32 and at least one clamp 34. In this embodiment, four clamps 34 are shown separating, organizing and supporting the stringer 20 of surgical instruments 22.

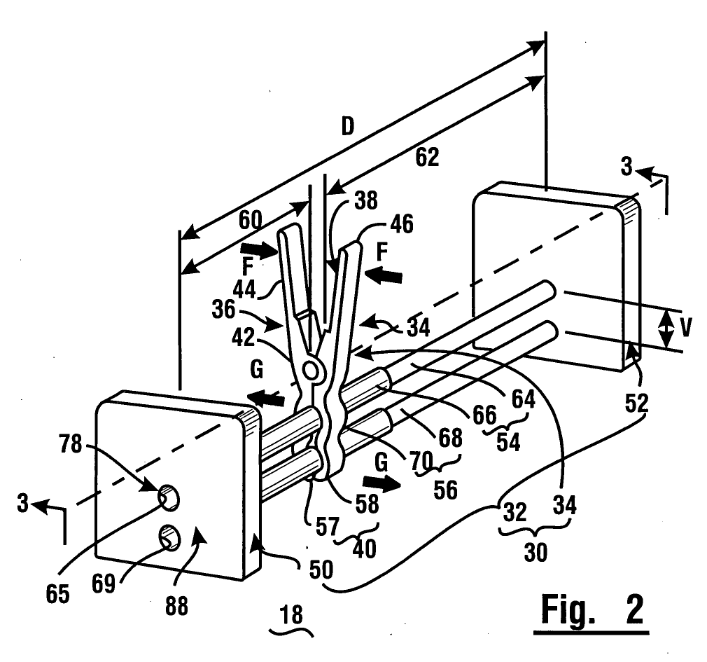

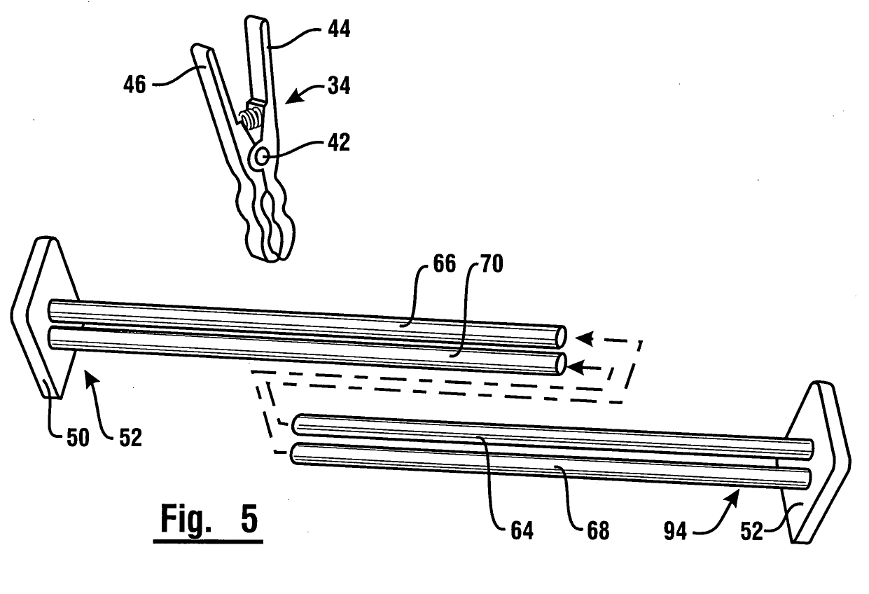

As illustrated in FIG. 2, surgical instrument organizer assembly 30 includes an instrument stand 32 (hereinafter “stand”) and one clamp 34. Reference may also be made to FIG. 5 which shows the clamp 34 disassembled from the stand 32, which stand is also disassembled into its constituent parts for sterilization.

The clamp 34 is generally nondestructively removably secured to stand 32 at a pre-selected location along a length D thereof by the nurse, assistant or doctor, as mentioned herein. While one clamp 34 is illustrated in FIG. 2, any desired number of clamps, such as the clamp 34, may be used with a stand, such as instrument stand 32, in the surgical instrument organizer assembly 30 configured according to exemplary embodiments of the invention.

The exemplary clamp 34 includes a pair of similarly-sized, elongated first and second arms 36, 38, respectively, that meet at one end of clamp 34 to form a jaw 40 thereof. The first arm 36 and the second arm 38 are secured to each other at a shared medial location by a spring-loaded hinge 42 that urges the first arm 36 and the second arm 38 into the closed condition of the clamp 34 shown with the jaw 40 of the clamp 34 selectively clasping the stand 32. Nonetheless, the first arm 36 and the second arm 38 engage in relative pivoting movement out of the closed position of the clamp 34, when the biasing effect of the hinge 42 is overcome by sufficient counteracting force applied between the first arm 36 and the second arm 38.

Accordingly, the end of the first arm 36 on the opposite side of the spring-loaded hinge 40 from the jaw 40 is formed into a first handle 44, while the end of the second arm 38 on the opposite side of the hinge 40 from the hinge 40 is formed into a second handle 46. When a force F is applied by the fingers of a medical practitioner to the first handle 44 and to the second handle 46 in the directions indicated by correspondingly labeled arrows in FIG. 2, the jaw 40 opens in the manner indicated by arrows G allowing the grip of the jaw 40 to be released from the stand 32. According to the needs of medical personnel, the exemplary clamp 34 may then be repositioned at a different location along the length of the stand 32, or removed entirely from the stand 32 and thus, from the surgical instrument organization system 30. While the exemplary clamp 34 is biased about the hinge 40 by a spring, it is recognized that exemplary clamps may or may not have a biasing member. Furthermore, the exemplary clamp 34 may include a tension or compression member for supplying the requisite clamping force to secure the clamp 34 to the instrument stand 32. It should be understood that the structure of clamp 34 is exemplary and in other embodiments other types of clamps suitable for holding surgical instruments in a desired orientation may be used.

The structure of the exemplary stand 32 will be described in detail by reference first to FIG. 2. The remote ends of the stand 32 include a first footing 50 and a second footing 52 that support the stand 32 on the upper surface of the mayo stand 18 when the surgical instrument organizer assembly 30 is assembled thereupon with a stringer of surgical instruments in preparation for surgery. Extending between and upheld by the first footing, 50 and the second footing 52 are an elongated instrument support 54 and therebelow, at a height H above the upper surface of the mayo stand 18, a stand stabilization shaft or support 56.

Advantageously, the exemplary instrument support 54 and the stabilization shaft 56 of the stand 32 allow the jaw 40 of the clamp 34 to be grippingly supported in the closed condition thereof. Toward that end, the opposed faces 57, 58, of the jaw 40 may be configured as shown in FIG. 2 to conform closely to the exterior profile and the vertical separation V between the instrument support 54 and the stabilization shaft 56.

When employed as part of the surgical instrument organizer assembly 30, the clamp 34 separates the distance D between the first footing 50 and the second footing 52 into a first instrument disposition slot 60 adjacent to first footing 50 and a second instrument disposition slot 62 adjacent to the second footing 52. The first instrument disposition slot 60 is as a result separated from the second instrument disposition slot 62 by a distance S representing the width of the clamp 34 as measured parallel to the hinge 42, the instrument support 54, and the stabilization shaft 56.

The use with the stand 32 of additional clamps, such as clamp 34, will serve to further subdivide the distance D into additional and smaller instrument disposition slots along the length of the stand 32. In FIG. 1, for example, the exemplary surgical instrument organizer assembly 30 is shown to employ four clamps 34, thus subdividing the distance D between the first footing 50 and the second footing 52 into five distinct instrument disposition slots P, Q, R, S, T, along the length of the stand 32. The sizes of instrument disposition slots P, Q, R, S, T, can be varied at will by medical personnel according to the positions chosen selectively therefor, for each of the clamps 34.

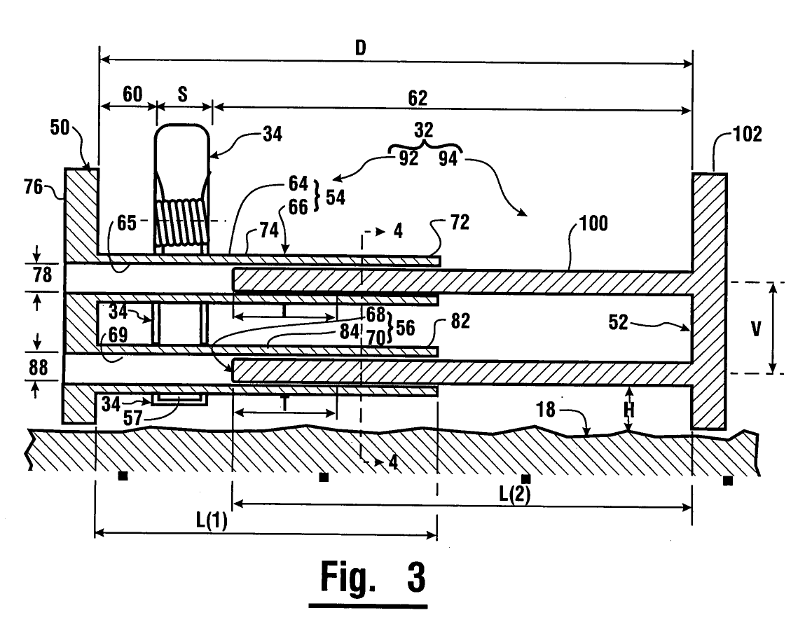

As shown in FIG. 3, each of the instrument support 54 and the stabilization shaft 56 is a telescoping structure which includes an inner rod 64, 68 that is slidably longitudinally received within a hollow outer rod 66, 70, respectively. Thus, the inner support rod 64 is cantilevered from the second footing 52 and slidably disposed within a longitudinally extending interior passageway 65 in the hollow outer support rod 66 that projects from the first footing 50 to produce the instrument support 54. Similarly, the inner stabilization rod 68 is slidably disposed within a longitudinally extending interior passageway 69 in the hollow outer stabilization rod 70 that projects from the first footing 50 to produce the stabilization shaft 56.

To avoid the inclusion of problematic dead end spaces within the components described herein of the stand 32, the interior passageway 65 in the outer support rod 66 and the interior passageway 69 in the outer stabilization rod 70 are open at both ends to the exterior of the stand 32.

Thus, while the end of the interior passageway 65 at the free end 72 of the outer support rod 66 actually receives the free end 74 of the inner support rod 64, the opposite end of the interior passageway 65 opens through the first footing 50 on the face 76 thereof, opposite from the outer support rod 66 in an upper clean out aperture 78.

Similarly, the end of the interior passageway 69 at the free end 82 of outer support rod 70 receives free end 84 of the inner support rod 68, and the opposite end of the interior passageway 69 also opens through the first footing 50 on the face 76 in a lower clean out aperture 88.

By means of this exemplary arrangement of components, the first footing 50 with the outer support rod 66 and the outer stabilization rod 70 projecting therefrom is slidable at will toward or away from the second footing 52 with the inner support rod 64 and the inner stabilization rod 68 projecting therefrom. Advantageously, the exemplary stand 32 may be increased or decreased in length, thus rendering distance D between the first footing 50 and the second footing 52 variable at the convenience of a user of the surgical instrument organizer assembly 30.

As shown in FIG. 3, the outer support rod 54 and the outer stabilization rod 70 have a first common length L(1), while the inner support rod 64 and the inner stabilization rod 68 have a second common length L(2). In those terms, the maximum length achievable for distance D between the first footing 50 and the second footing 52 by sliding the first footing 50 and the second footing 52 away from each other would be equal to the combination of the first common length L(1) plus the second common length L(2). Upon extension to the maximum length+L(1)+L(2), the stand 32 would be separatable into a first stand half or section 92 made up of the first footing 50, the outer support rod 54 mid the outer stabilization rod 70, and a second stand half or section 94 made up of the second footing 52, the inner support rod 64 and the inner stabilization rod 68.

To forewarn a user of the stand 32 that further movement of the first stand section 92 apart from the second stand section 94 risks disassembly of the stand 32, the surface of the exemplary inner support rod 64 for a distance T adjacent to the free end 74 thereof and the surface of the exemplary inner stabilization rod 68 for a distance T adjacent to the free end 84 thereof, may be colored, textured, or coated in a manner that contrasts visually with the balance of the surface of the inner support rod 64 and the inner stabilization rod 86, respectively. When these visually contrastingly portions of the inner support rod 64 and the inner stabilization rod 86 are observed, respectively, at the free end 72 of the outer support rod 66 and at the free end 82 of the outer stabilization rod 70, a user is advised sensorially, such as visually, that the fullest extension of the stand 32 is being approached.

Disassembly of the exemplary stand 32 into the first stand section 92 and the second stand section 94, and unclamping all clamps 34 therefrom, facilitate sterilization, as illustrated in FIG. 5. Optionally, disassembly provides the opportunity to pass any of the free ends of any of the inner support rod 64, the outer support rod 66, the inner stabilization rod 68, or the outer stabilization rod 70 through apertures in handles of surgical instruments. Reassembling the first and the second section 92, 94, with the inner support rod 64, the outer support rod 66, the inner stabilization rod 68, or the outer stabilization rod 70 passing through the apertures in the handles of surgical instruments captures those surgical instruments as a group with the stand 32, whereupon the assembly may be manipulated as a unit for sterilization, transport, or other organizational purposes. However, it is conventionally recognized that a stringer wire (not shown) is customarily utilized to capture the above mention surgical instruments creating a stringer suitable for sterilization, transport, or utilization with this embodiment.

It may be convenient, but not necessary, that the first common length L(1) of the outer support rod 54 and the outer stabilization rod 70 is equal to the second common length L(2) of the inner support rod 64 and the inner stabilization rod 68.

Where, as illustrated in FIG. 3, the ends of both the outer support rod 66 and the outer stabilization rod 70 adjacent to the first footing 50 are closed off, the minimum length achievable for distance D between the first footing 50 and the second footing 52 by sliding the first footing 50 and the second footing 52 toward each other is equal to the first common length L(1) of the outer support rod 66 and the outer stabilization rod 70 when the second common length L(2) is equal to or less than the first common length L(1). When the first common length L(1) of the outer support rod 66 and the outer stabilization rod 70 is less than the second common length L(2) of the inner support rod 64 and the inner stabilization rod 68, then the distance D between the first footing 50 and the second footing 52 is minimized at the second common length L(2) when closed off; and is further minimized at the first common length L(1) when the free end 74 of the inner support rod 64 extends toward or from the face 76 of the first footing 50 through the upper clean out aperture 78, and the free end 84 of the inner stabilization rod 68 extends toward or from the face 76 of the first footing 50 through the lower clean out aperture 88.

Furthermore, if the end of either the outer support rod 54 and the outer stabilization rod 70 adjacent to the first footing 50 is closed off, then the minimum length achievable for distance D between the first footing 50 and the second footing 52 by sliding the first footing 50 and the second footing 52 toward each other is equal to the larger of the first common length L(1) of the outer support rod 66 and the outer stabilization rod 70 and the second common length L(2) of the inner support rod 64 and the inner stabilization rod 68.

Optionally, either of the inner support rod 64 and the inner stabilization rod 68 may be fabricated as hollow, tubular structures. Of course these approaches are exemplary and in other embodiments other approaches may be used.

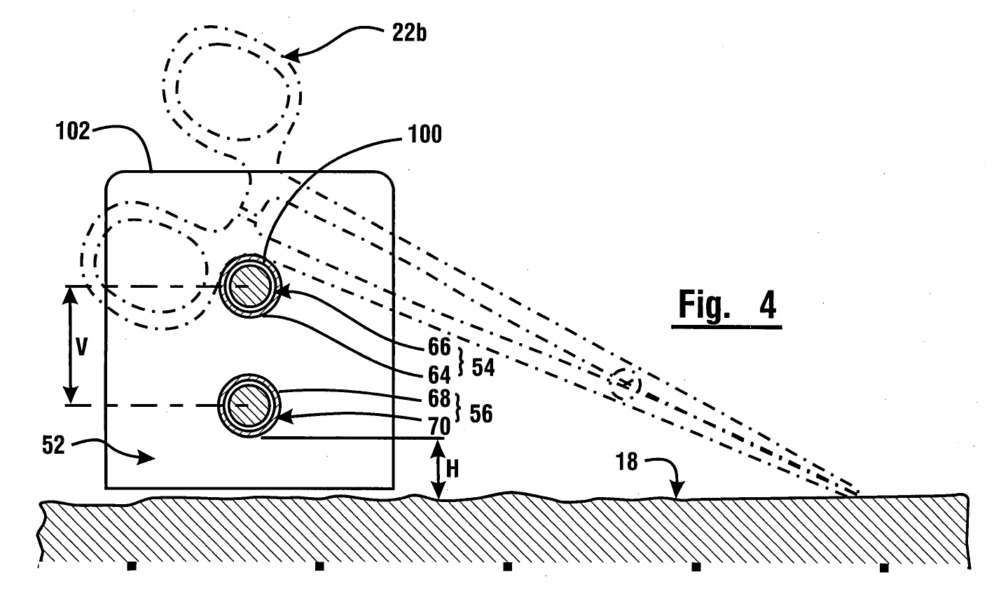

As appreciated by reference to the transverse cross sections shown in FIG. 4, each of the exemplary inner support rod 64, the outer support rod 66, the inner stabilization rod 68, and the outer stabilization rod 70 has a circular outer profile. It is recognized that other shapes of outer profiles for these rods 64, 66, 68, 70 of the stand 32 may be desirable and workable in other embodiments. In still another aspect of exemplary embodiments, the cross-sectional size and outer profile of the inner support rod 64 and the inner stabilization rod 68 relative to the cross-sectional size of the interior passageway 65 in the outer support rod 66 and the interior passageway 69 in the outer stabilization rod 70 may be such as to permit the inner support rod 64 and the inner stabilization rod 68 to be slidably receivable along the interiors 65, 69 of the outer support rod 66 and the outer stabilization rod 70, respectively.

In this regard, a close positionally engaging fit, e.g. sliding fit, may be employed between constituent rods, however, a close or snug fit may be used to advantage.

Further, as shown in FIG. 4 the cross-sectional size and outer profile of the outer support rod 66 and the outer stabilization rod 70 are shown to be approximately equal. It is recognized that in other embodiments the outer support rod 66 and the outer stabilization rod 70 may have different sizes. It may, for example, be desired in enhancing the structural strength of the stand 32 to make the cross-sectional size and outer profile of the outer stabilization rod 70 large, or even substantially larger, than the cross-sectional size and outer profile of the outer support rod 66. Corresponding adjustments to the cross-sectional size and outer profiles of the inner support rod 64 and the inner stabilization rod 68 may be desired to maintain relative slidability between the first stand section 92 and the second stand section 94, of the stand 32.

Furthermore, the relative positioning of the instrument support 54 and the stabilization shaft 56 need not be only as shown in FIG. 4. In alternative embodiments the instrument support 54 and the stabilization shaft 56 may be offset horizontally, or separated vertically to a greater or a lesser extent than depicted. It is advisable in some embodiments, that a top surface 100 of the instrument support 54 be located sufficiently below an upper edge 102 of, for example, the second footing 52 as to enable a surgical instrument, such as surgical instrument 22b shown in phantom in FIG. 4, to be rested on the top surface 100 of the instrument support 54 and leaned stably against, for example, a portion of the second footing 52 thereabove.

It is further recognized that neither it is necessary that, as illustrated herein, the outer telescoping portions of both the instrument support 54 and the stabilization shaft 56 project from a single one of the first or the second footings 50, 52, respectively. One such outer telescoping portion could project from one of the first or the second footings 50, 52 while the other of the outer telescoping portions projects from the other of the first and the second footings 50, 52, respectively. Corresponding compensatory structural changes in the manner of supporting the inner of the telescoping portions of the instrument support 54 and the stabilization shaft 56 would produce an effective, functioning stand, like the stand 32. Moreover, the instrument support 54 of the stand 32 may replace the stabilization shaft 56 or the stabilization shaft 56 may replace the instrument support 54. Also, either of the instrument support 54 and the stabilization shaft 56 may be omitted from the stand. Moreover, in some embodiments additional instrument supports and stabilization shafts may be included with the stand 32.

The entirety of the exemplary surgical instrument organizer assembly 30, including all components of each of the stand 32 and clamps 34, may be fabricated from durable, heat and moisture resistant materials that are medically sterilizeable and advantageously permit the surgical instrument organizer assembly 30 to be reusable in subsequent surgical procedures. Materials suitable for the exemplary surgical instrument organizer assembly 30 may include stainless steel, autoclavable plastics, and any other autoclavable materials in any combination suitable for assembly as shown and taught herein, It is recognized that the exemplary surgical instrument organizer assembly 30, including all components of each of the stand 32 and clamps 34, may as an assembly, or individually, be made of materials that are suitable for use in surgical procedures and may be either reusable or disposable.

In certain alternative embodiments, the instrument stand may be a nonadjustable stand 32 having a first footing 50 and a second footing 52 separated by at least one of an instrument support 54 and the stabilization support 56.

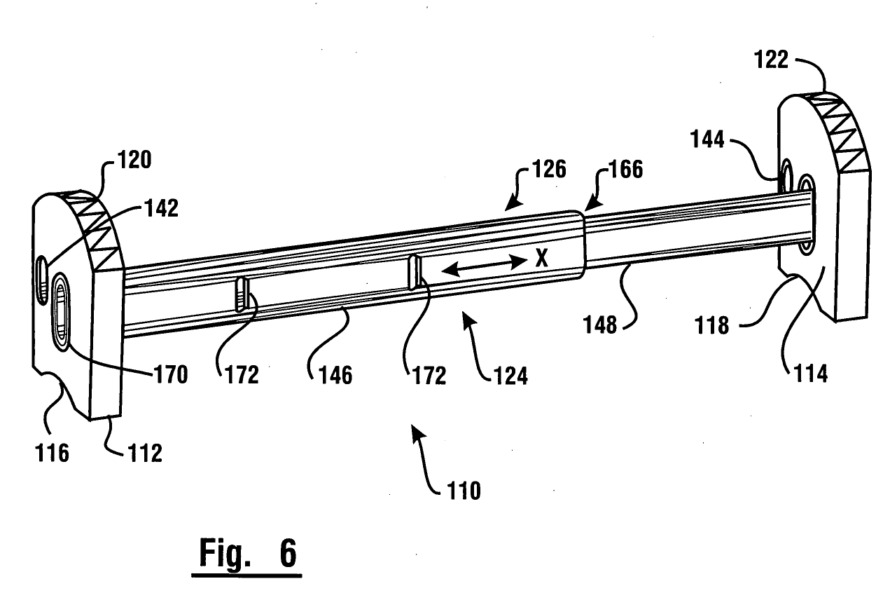

An alternative embodiment of a surgical instrument stand and instrument organizer assembly is shown in FIGS. 6 through 21. This alternative embodiment includes an instrument stand generally indicated 110 in FIG. 6. Instrument stand 110 includes a first footing 112 which is alternatively referred to herein as an end plate. Instrument stand 110 also includes a second footing or end plate 114. In the exemplary embodiment the end plates each have a bottom face 116 and 118 respectively, for engaging a supporting surface such as a mayo stand, table, sterilization tray, or other suitable supporting surface. End plates 116 and 114 also have curved convex upper surfaces 120 and 122 respectively. It should be understood that this configuration of the end plates is exemplary and in other embodiments other structures may be used.

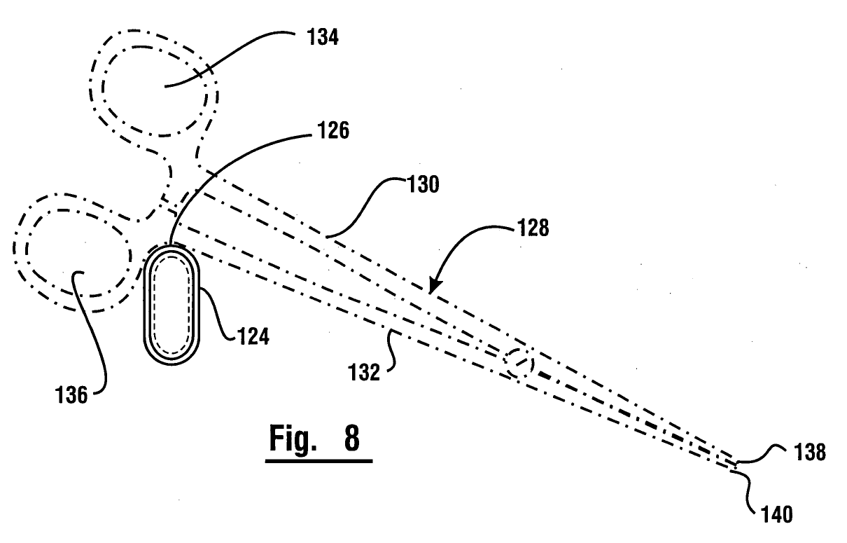

A support generally indicated 124 extends between the end plates. The support 124 extends along an axial direction generally indicated X. The support 124 includes an upper surface 126. Upper surface 126 comprises a curved convex surface in the exemplary embodiment. The upper surface 126 is configured to engage surgical instruments such as instrument 128 shown in phantom in FIG. 8. In this exemplary embodiment the support stand and assembly may be useful in supporting surgical instruments of the types that include a pair of arms such as instrument arms 130 and 132 of instrument 128, and which arms are relatively rotationally movable through selective manual manipulation. Further as later discussed, the exemplary alternative embodiment may be useful in connection with surgical instruments that include instrument arms that are operatively connected to finger holes such as finger holes 134 and 136 of instrument 128. In addition the exemplary stand and assembly may also be useful in dealing with such surgical instruments that include instrument arms with engageable tips such as tips 138 and 140 of instrument 128. Of course it should be understood that surgical instruments of this type are not the only surgical instruments for which exemplary embodiments may have utility. However, instruments having structures of this type are commonly used in surgical procedures and therefore the ability of exemplary embodiments to be used in conjunction with such instruments may be generally beneficial.

Referring again to FIG. 6, the exemplary embodiment of stand 110 includes a first aperture 142 in end plate 112. Aperture 142 extends through end plate 112 and in the exemplary embodiment is a generally elongated aperture. An aperture 144 extends in end plate 114. In the assembled condition of the instrument stand, the apertures 142 and 144 are generally aligned along an axis parallel to the axial direction. As shown, the aperture 142 is located adjacent to an opening 170 in the end plate 112. The location of the aperture 142 relative to the opening 170 can range from substantially horizontal alignment to substantially vertical alignment therewith. As later explained, apertures 142 and 144 are configured to accept a stringer rod therein. Further as shown in FIG. 6, in the exemplary embodiment aperture 142 is elongated and larger than aperture 144. In addition, each of the apertures is countersunk with a tapered surface on each side of the aperture. These features facilitate the insertion of a stringer rod into the apertures. Of course these structures are exemplary.

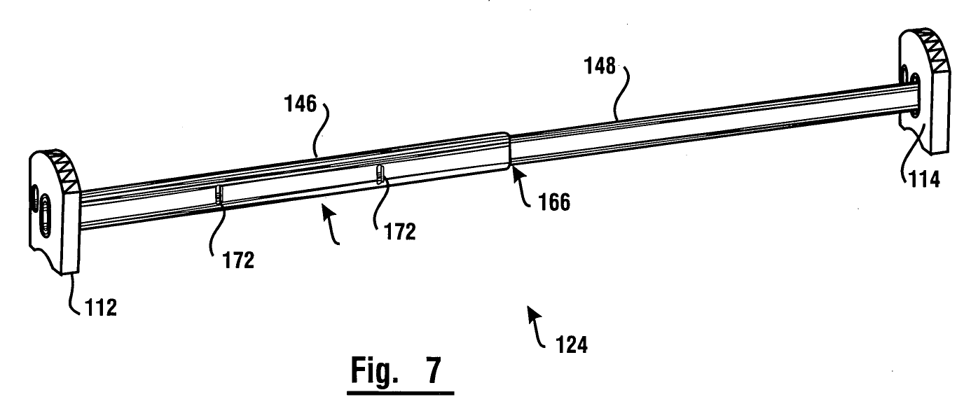

In the exemplary embodiment, support 124 includes an axially elongated first member 146 and an axially elongated second member 148. The exemplary members 146 and 148 are relatively movable in telescoping relation. This enables the end plates to be relatively moved toward or away from one another. This is represented in FIG. 7 in which the end plates are shown moved further apart than in FIG. 6. Also in this alternative embodiment, member 148 may include markings or other indicators to indicate to a user when the end plates have been extended apart to such an extent that the limits on displacement of the end plates is being reached.

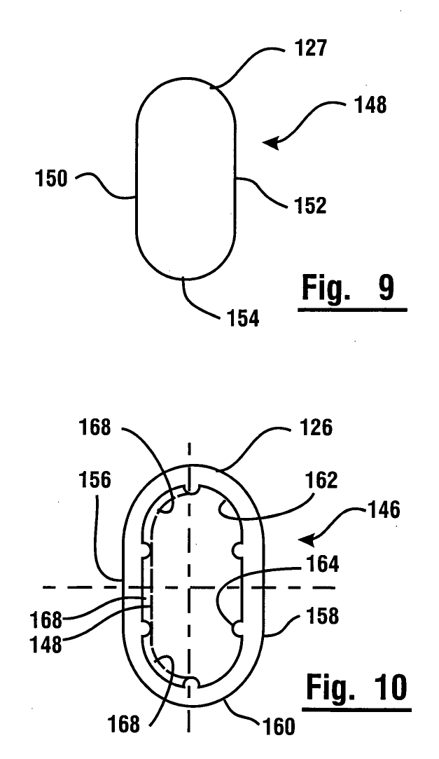

In the exemplary embodiment each of members 146 and 148 in cross section have a generally oval shaped contour as best shown in FIGS. 9 and 10. In the exemplary embodiment member 148 is a generally solid structural member that is in rigidly fixed connection with end plate 144. In the exemplary embodiment the member 148 generally includes no external openings. This is preferable to limit the risk that tissue, bodily fluids or other undesirable material may collect on or in member 148.

As shown in FIG. 9, in cross section member 148 has a generally elongated oval shape and is bounded by a pair of generally parallel flat sides 150, 152. Flat sides 152 are connected through the curved convex upper surface 126 on member 148 and a correspondingly convex shape lower surface 154.

Likewise as shown in FIG. 10, member 146 has a generally oval external shape that is bounded by a pair of generally parallel flat sides 156 and 158. Member 146 is bounded externally by the upper surface 126 thereof which is a curved convex surface as well as a similarly shaped lower surface 160.

In an exemplary configuration the member 146 is hollow. Exemplary member 146 is bounded internally in cross section by an inner surface 162. Inner surface 162 includes a plurality of inward extending projections 164. In the exemplary embodiment the inward extending projections are sized to engage the outer surface bounding member 148. In an exemplary configuration, the inward extending projections are configured so as to enable member 148 to move relative to the member 146 in engagement with at least some of the inward extending projections 164. The inward extending projections 164 allow cleaning (e.g., sterilization) of both the inner surface 162 and the outer surface of member 148 while that portion of member 148 is positioned in member 146.

In the exemplary embodiment, member 148 extends in an opening 166 in member 146 that is disposed at an end of member 146 away from end plate 112. Member 148 is movable in telescoping engagement through the opening and along the interior area of member 146.

Further as can be appreciated, when member 148 is engaged with member 146 a plurality of flow spaces extend in the area between the outer surface of member 148 and the inner surface 162 of member 146. As shown in FIG. 10, a dashed line represents a portion of the profile of the outer surface of member 148. Flow spaces 168 thus extend in the voids formed within the interior area. As later discussed in detail, these flow spaces 168 in the exemplary embodiment are suitable for accepting sterilizing fluid material therein so as to facilitate sterilization of the stand in an assembled condition. Of course it should be understood that these approaches are exemplary and in other embodiments other approaches may be used.

As further shown in FIGS. 6 and 7, the opening 170. Opening 170 extends through the end plate 112 and into the interior area of member 146 which is rigidly connected thereto. As a result, opening 170 is in fluid communication with the interior area of member 146 including the flow spaces 168 therein. Further in the exemplary embodiment member 146 includes openings 172 in the sides thereof. Openings 172 in the exemplary embodiment extend in both sides of the member 146 and are also in fluid communication with the flow spaces 168 as well as opening 170. As can be appreciated this construction enables fluid sterilization material to more readily flow into and through the interior area of member 146 thus facilitating sterilization. These approaches are exemplary and in other embodiments other approaches such as both members being hollow with flow openings, may be used.

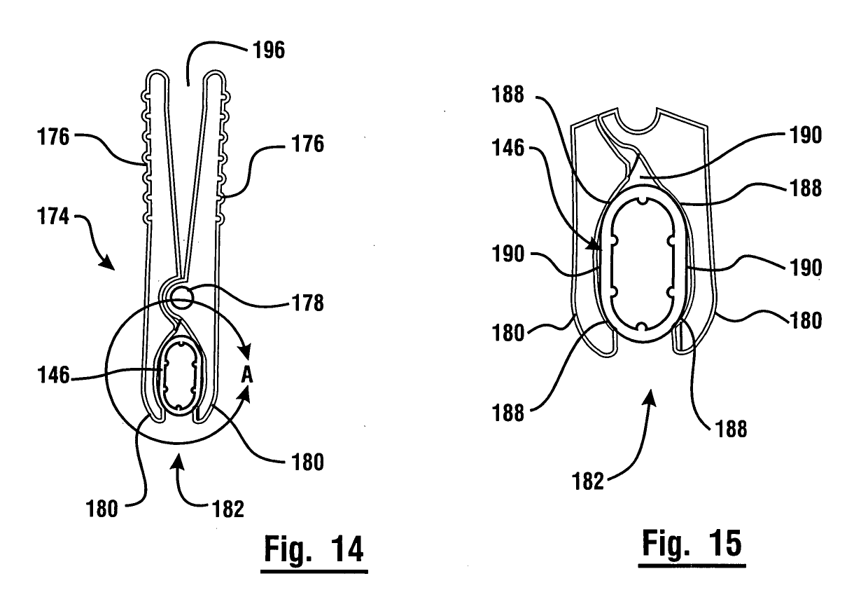

FIG. 14 shows an exemplary clamp 174 used in this exemplary embodiment. Clamp 174 is configured to be releasibly connectable with support 124. Further in the exemplary embodiment, clamps 174 are selectively axially positionable along the support. In this way the clamps enable selectively configuring the size of storage areas which are alternatively referred to herein as storage slots, for positioning surgical instruments.

In the exemplary embodiment each clamp 174 includes a pair of clamp arms 176. Clamp arms 176 are connected and are rotationally movable relative to one another through a pivot member 178. In the exemplary embodiment each arm 176 includes a jaw portion 180. Jaw portions 180 of the exemplary embodiment are configured to engage support 126. This is accomplished in an exemplary embodiment through the action of a spring member which operatively extends between the arms and biases the jaw portions 180 toward one another. As can be appreciated in the exemplary embodiment the jaw portions 180 form a gripping jaw generally indicated 182 for gripping and holding the support 124.

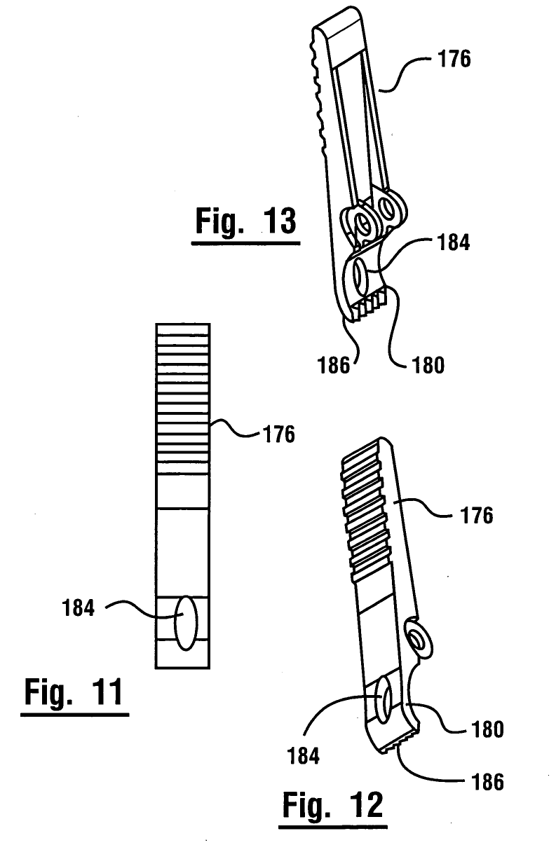

Further in the exemplary embodiment and as best shown in FIGS. 11 and 12, each jaw portion includes therein a jaw aperture 184. In the exemplary embodiment the jaw apertures 184 provide fluid communication through the jaw portion to the interior area thereof.

In an exemplary embodiment each of the jaw portions terminate in teeth generally indicated 186 that are engaged with the support 126. The teeth 186 are useful in holding the clamp in fixed position relative to the support. Further in the exemplary embodiment when the clamp 174 is released from the support and the jaw portions are moved toward one another to the fullest extent through the operation of the biasing force of the spring, the teeth remain slightly disposed. This feature in the exemplary embodiment enables sterilizing fluid material to flow between the teeth to facilitate sterilizing the clamps. Of course it should be understood that this approach is exemplary and in other embodiments other approaches may be used.

FIGS. 14 and 15 show the exemplary embodiment of the clamp 174 engaged with the exterior surface of member 146. As best shown in FIG. 15 in this condition the jaw portions 180 engage the exterior surface of member 146 in generally four discrete engaging locations 188. Between the engaging locations 188 are flow spaces generally indicated 190. Flow spaces 190 are configured to enable fluid sterilization material to flow therein. Further the flow of fluid sterilization material into and through the flow spaces is facilitated in the exemplary embodiment by flow through the jaw apertures 184. Thus as can be appreciated this exemplary configuration facilitates sterilization with the clamps installed in engagement with the support. Of course this approach is exemplary and in other embodiments other approaches may be used.

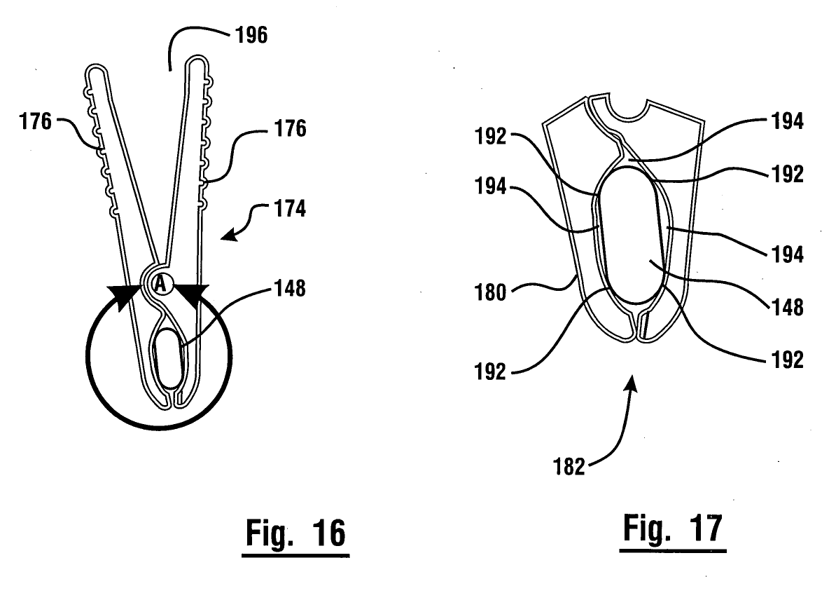

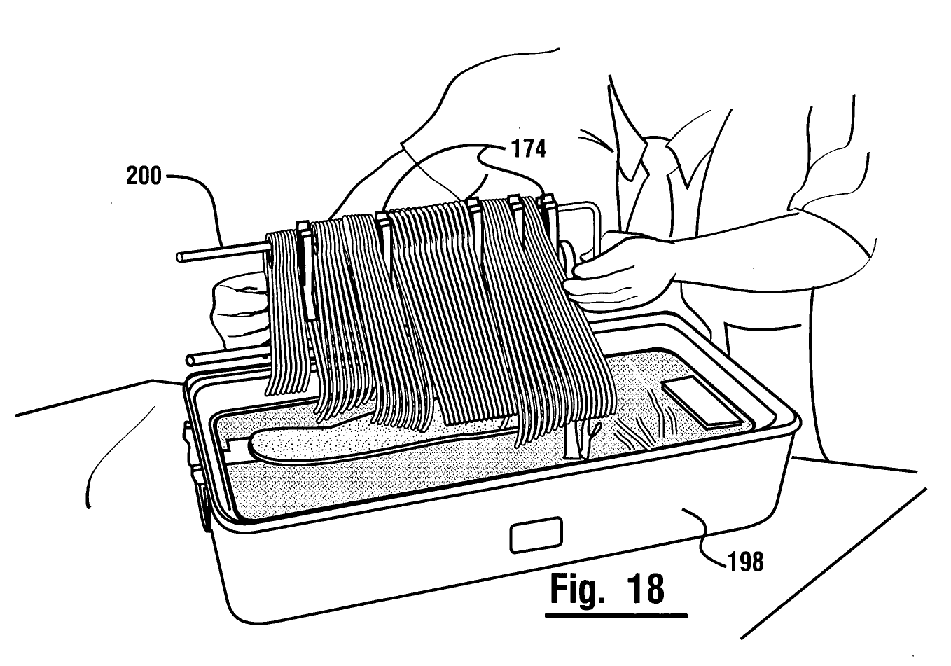

FIGS. 16 and 17 show the exemplary clamp 174 in engagement with member 148 of support 124. As best shown in FIG. 17, jaw portions 180 engage member 148 in four engaging locations 192. Flow spaces 194 extend between the engaging locations 192. As is the case with regard to engagement of a clamp with member 146, the flow spaces facilitate the flow of fluid sterilization material into and between the areas of engagement. Such flow is facilitated by the jaw apertures 184. Thus the exemplary configuration facilitates sterilization of the instrument stand and clamps with the clamps installed.

In the exemplary embodiment when the clamps 174 are installed in engagement with the support 124, an open area 196 extends between the arms 176 of the clamp. This open area is suitable in the exemplary embodiment to accept a stringer rod therein. Thus in the exemplary embodiment a stringer rod, which may be of U-shaped configuration, may extend through apertures 142 and 144 of the end plates as well as through the open areas 196 of the clamps. Further the arms of the clamps may capture and limit movement of the stringer rod so as to assure that it remains engaged in the open area of the clamps. This can facilitate holding the instruments in engagement with the instrument stand and in the desired orientation relative thereto. In the exemplary embodiment the stringer rod may in addition extend through finger holes of the instruments. In such circumstances the extension of a stringer rod through the finger holes may further assist in holding the surgical instruments in the desired orientation. In addition the stringer rod may also serve to hold the tips of the arms of the surgical instruments disposed from one another. This may be particularly useful for activities such as sterilization of the instruments so that any material that may have been collected on the tips is removed and neutralized.

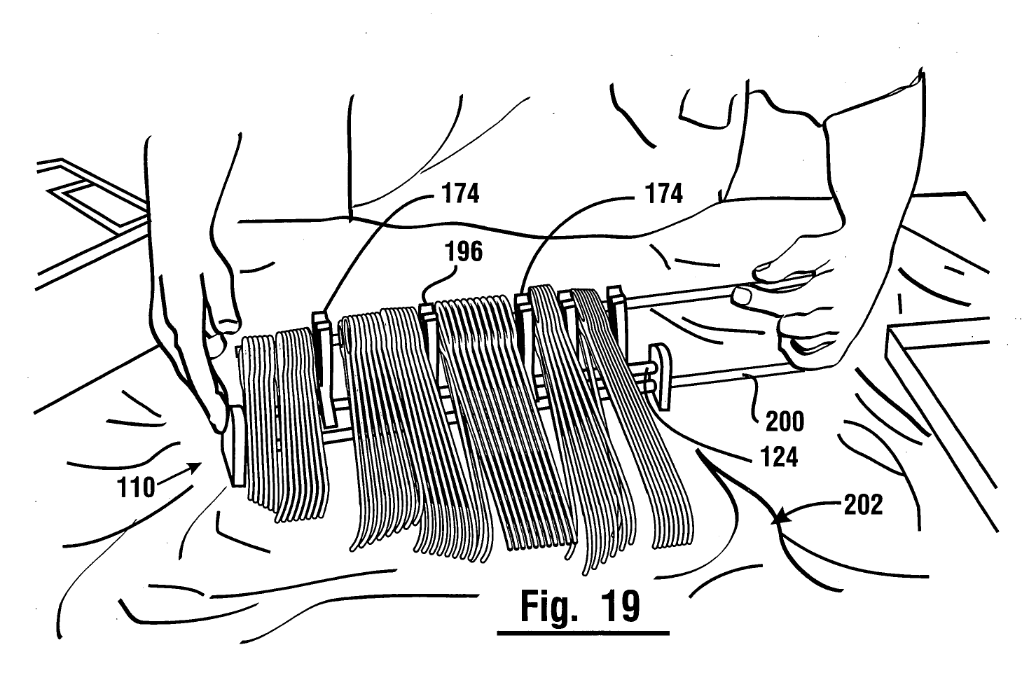

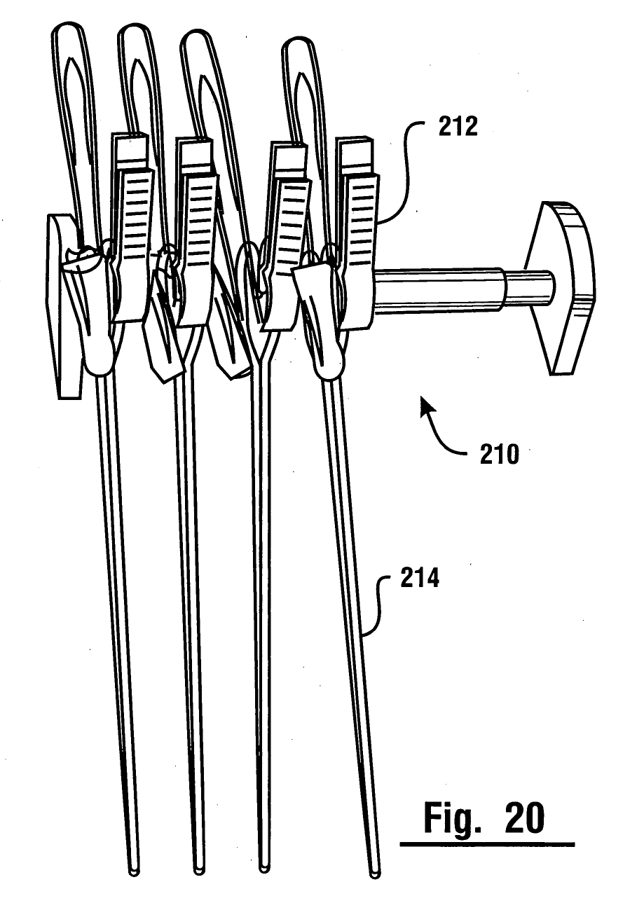

Certain desirable features of the exemplary embodiments, and the methods that may be carried out therewith, are illustrated in FIGS. 18 and 19. In the exemplary embodiment a user utilizing the instrument stand and assembly may adjust the distance between the end plates by moving them relative to one another. Further as can be appreciated, in the exemplary embodiment the structure of the telescoping members enables relative movement but also helps to generally hold the members in relative position in the absence of applied force.

Once the end plates have been disposed a suitable distance clamps are engaged with the support so as to divide the axial length of the support into separate instrument holding areas. After the clamps have been engaged and suitably oriented relative to the support, stringers of surgical instruments may be positioned in the areas by engaging such instruments with the support. In the case of instruments including movable instruments arms, one instrument arm is generally engaged with the upper outer surface of the support. Of course it should be understood that the nature of the engagement of the surgical instrument with the support may depend on the desired orientation and type of instrument.

In an exemplary method a generally U-shaped stringer rod may be extended through the apertures in the end plates as well as through the open areas of the clamps. In some embodiments and for some instruments, the stringer rod may also be extended through the finger holes operatively connected to one of the instrument arms of each instrument. The engagement of the stringer rod in the finger holes of some instruments may be operative to hold the tips of the instrument arms apart. Thereafter the stringers of instruments, the instrument stand, clamps and stringer rods may all be placed in a suitable sterilization device. In this manner fluid sterilization material such as steam or other fluid substances may flow on and through the instruments and the components thereof. This facilitates sterilizing the instruments as well as the components of the assembly.

After sterilization in an exemplary method, the assembly including the instruments may be placed on a sterile support surface in a surgical facility. This may include for example placing the instrument stand on a mayo stand or other suitable support surface. Once the assembly has been placed on the support surface, the stringer rod may be removed from engagement with the apertures, instruments, and clamps. Once the stringer rod is removed, the instruments remain positioned in supporting connection with the stand in a desired orientation, respectively separated by clamps, and can be manually removed and used during the surgical procedure.

In accordance with an exemplary method, at the conclusion of the surgical procedure the instruments may be returned into supporting connection with the instrument stand. The stringer rod may thereafter be extended into the apertures, open areas of the clamps, and/or finger holes of the instruments. With the stringer rod engaged, the instruments and stand may be moved as an assembly to a suitable location such as into a sterilization device. Of course it should be understood that this approach is exemplary and in other embodiments other approaches may be used.

FIG. 18 shows some of the devices that may be used in connection with some of the procedures previously discussed in connection with the exemplary method. As shown in FIG. 18, the entire assembly (including the instruments) may be sterilized in a sterilization container generally indicated 198. As shown in FIG. 18, the assembly including the stringers of surgical instruments may be readily moved as an assembly with the U-shaped stringer rod 200 extending through the apertures 142 and 144, the open areas 196 of the clamps 174, and the finger holes of the instruments.

FIG. 19 shows instruments and stand placed in supporting connection with a sterile supporting surface generally indicated 202. The stringer rod 200 is shown being withdrawn from engagement with the assembly by movement to the right as shown in FIG. 19. As previously discussed, removal of a stringer rod 200 leaves the stringers and surgical instruments operatively supported on the support 124 and held thereon in the desired position by operative engagement with the clamps 174. The instruments may thus be readily manually removed by medical personnel for use in carrying out the surgical procedure. Further, the instruments remain organized in the desired spaced manner so as to facilitate the use thereof during the procedure.

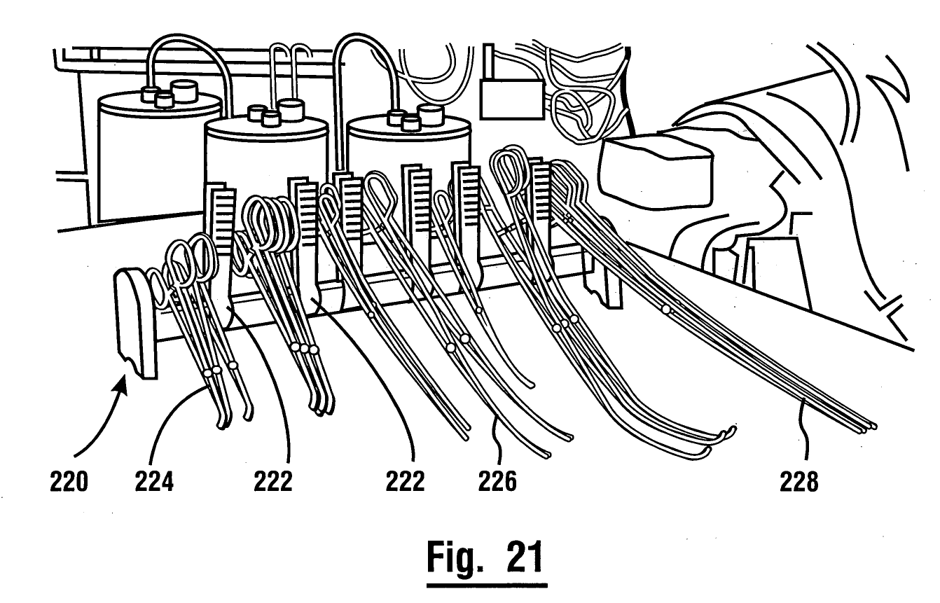

FIGS. 20 and 21 further demonstrate the use of the exemplary instrument stand and clamps in connection with supporting types of surgical instruments. FIG. 20 shows an instrument stand 210 in connection with and supporting surgical instruments 214. Clamps 212 separate surgical instruments. FIG. 21 shows an instrument stand 220 in connection with and supporting surgical instruments. Clamps 222 can separate different varieties and/or sizes of surgical instruments (e.g., tools, implements, etc.) 224, 226, 228 which can have different functionality and usefulness.

As can be seen from FIGS. 20 and 21 and prior figures, the capability in an exemplary embodiment to selectively position clamps facilitates holding numerous different types and sizes of surgical instruments in supporting engagement therewith. Clamps can be used to separate surgical instruments individually, by instrument types, and/or by instrument sizes. This flexibility enables exemplary embodiments to be useful in connection with numerous different types of surgical procedures. Of course these instruments, structures, and methods are exemplary and in other embodiments other approaches may be used.

Thus the exemplary embodiments of the apparatus and system achieve at least some of the above stated objectives, eliminate difficulties encountered in the use of prior devices and systems and attain the useful results described herein.

In the foregoing description certain terms have been used for purposes of brevity, clarity and understanding, however no unnecessary limitations are to be implied therefrom because such terms are used for descriptive purposes and are intended to be broadly construed. Moreover, the descriptions and illustrations herein are by way of examples and the invention is not limited to the features shown and described.

In the following claims any feature described as a means for performing a function shall be construed as encompassing any means known to those skilled in the art as being capable of carrying out the recited function, and shall not be limited to the means shown or described for performing the recited function in the foregoing description, or mere equivalents thereof.

Having described the features, discoveries and principles of the invention, the manner in which it is constructed and operated, and the advantages and useful results attained, the new and useful structures, devices, elements, arrangements, parts, combinations, systems, equipment, operations, methods, processes and relationships are set forth in the appended claims.

I claim:

1. A surgical instrument stand apparatus comprising:
a first end plate,
a second end plate,
at least one support extending between the first end plate and the second end plate, wherein the at least one support extends in an axial direction,
wherein the at least one support includes at least one outer surface configured to operatively engage first instrument arms of surgical instruments having two relatively rotationally movable instrument arms,
at least one clamp, wherein each clamp is operatively engageable with the at least one support, wherein each clamp is selectively positionable along the axial direction between the end plates, wherein each clamp is configured to separate one surgical instrument from another surgical instrument, and wherein the at least one clamp is operative to hold a surgical instrument in operative engagement with the at least one support in a desired orientation.

2. The apparatus according to claim 1 wherein the at least one support comprises:
an axially elongated first member in operatively fixed connection with the first end plate;
an axially elongated second member in operatively fixed connection with the second end plate;
wherein the first member includes a first opening, wherein the first opening is configured to accept at least a portion of the second member therein in relatively movable relation;
wherein an axial length of the at least one support is adjustable.

3. The apparatus according to claim 2 wherein the first member includes at least one second opening, wherein the second opening is disposed from the first opening.

4. The apparatus according to claim 3 wherein at least one second opening extends in the first end plate.

5. The apparatus according to claim 4 wherein the first member in cross section extends in generally surrounding relation of the second member, wherein the first and second members are relatively axially movable in telescoping relation.

6. The apparatus according to claim 5 wherein the second member includes no external openings.

7. The apparatus according to claim 5 wherein the first member includes at least one second opening disposed axially in between the first opening and the at least one second opening in the first end plate.

8. The apparatus according to claim 5 wherein the first member is annular in cross section and generally uniform in configuration in the axial direction between the first end plate and the first opening, and wherein the first member has an inner surface, wherein the inner surface internally bounds the opening, and wherein the second member is movable relative to the first member in operative engagement with the inner surface.

9. The apparatus according to claim 8 wherein the inner surface comprises a plurality of inward extending projections, wherein the axially elongated second member is in operative engagement with the axially elongated first member through a plurality of such inward extending projections.

10. The apparatus according to claim 9 wherein a plurality of axially elongated projections comprise the plurality of inward extending projections.

11. The apparatus according to claim 9 wherein when the axially elongated first and second members are in engagement, a plurality of first flow spaces extend transversely between the plurality of inward extending projections and the axially elongated second member, wherein the plurality of first flow spaces are in a fluid communication with the at least one second opening.

12. The apparatus according to claim 1 wherein the plurality of first flow spaces are in fluid communication with a plurality of second openings.

13. The apparatus according to claim 11 wherein the first and second axially elongated members comprise a generally oval shape in cross section.

14. The apparatus according to claim 13 wherein the oval shape includes two opposed parallel flat side surfaces, wherein the instrument engaging outer surface comprises a convex surface that extends between the parallel flat sides.

15. The apparatus according to claim 13 wherein the first end plate includes a first aperture and the second end plate includes a second aperture, wherein the first and second apertures are generally aligned along a direction parallel to the axial direction, and wherein the first and second apertures are configured to accept an instrument supporting stringer rod therein.

16. The apparatus according to claim 15 wherein the at least one clamp includes an open area, wherein with the at least one clamp in engagement with the at least one support, a stringer rod is extendable through the first aperture and the second aperture and through the open area of each clamp.

17. The apparatus according to claim 16 and further comprising the stringer rod, wherein the stringer rod is generally U-shaped.

18. The apparatus according to claim 16 wherein each clamp comprises a pair of movable arms, and wherein the open area extends between the movable arms.

19. The apparatus according to claim 18 and further comprising:
at least one surgical instrument, wherein each surgical instrument includes a first instrument arm and a second instrument arm, wherein the first and second instrument arms are operatively connected in a relatively rotatable connection, and wherein at least one of the first and second instrument arms is in operative connection with a finger hole, and wherein the stringer rod extends through the finger hole.

20. The apparatus according to claim 19 wherein the first and second instrument arms terminate in respective first and second engageable tips, and wherein engagement of the stringer rod in the finger hole is operative to hold the first and second tips in separated relation.

21. The apparatus according to claim 19 wherein each clamp comprises a pivot member, wherein the clamp arms are relatively rotationally movable about the pivot member, and wherein each clamp arm is in operative connection with a jaw portion, wherein the pivot member is disposed intermediate of the jaw portions and the open area, and wherein each clamp includes a jaw, wherein the jaw is configured to engage the at least one support, and wherein the jaw includes the jaw portions.

22. The apparatus according to claim 21 wherein in cross section with the jaw in engagement with the support, a plurality of second flow spaces extend between the jaw portions and the support, wherein fluid flow is enabled between the support and the jaw portions through the plurality of second flow spaces.

23. The apparatus according to claim 22 wherein each jaw portion includes at least one jaw aperture, wherein each jaw aperture is in fluid communication with at least one of the second flow spaces.

24. The apparatus according to claim 1 wherein the at least one support comprises a plurality of fluid openings, wherein fluid is enabled to flow therethrough.

25. The apparatus according to claim 1 wherein the at least one support comprises an outer member and an inner member, wherein the outer member includes in cross section an opening having a plurality of inward extending projections, and wherein the inner member extends in the opening and is movably engaged with the outer member through the inward extending projections, and wherein the outer member is in operatively fixed connection with the first end plate and the inner member is in operatively fixed connection with the second end plate.

26. The apparatus according to claim 25 wherein the plurality of inward extending projections and the inner member define fluid spaces, and further comprising at least one fluid opening through the outer member, wherein the at least one fluid opening is in fluid connection with the plurality of fluid spaces.

27. The apparatus according to claim 1 wherein the at least one support in cross section has a generally oval shape, and wherein each of the at least one clamp includes a jaw, and wherein the jaw engages the at least one support and wherein in cross section with the jaw in engagement with the at least one support a plurality of flow spaces extend between the jaw and the at least one support.

28. The apparatus according to claim 27 wherein the jaw of each clamp includes at least one jaw aperture, and wherein each jaw aperture is in fluid communication with at least one flow space.

29. The apparatus according to claim 1 wherein the first end plate includes a first aperture and the second end plate includes a second aperture, and wherein the first and second apertures are generally aligned along a direction parallel to the axial direction, and wherein the first and second apertures are configured to accept an instrument supporting stringer rod therein.

30. The apparatus according to claim 29 wherein each at least one clamp includes an open area, wherein with the clamp engaged with the at least one support the open area is configured such that a stringer rod is extendable in the first and second apertures and in the open area of each clamp.

31. The apparatus according to claim 30 and further comprising the stringer rod, wherein the stringer rod is generally U-shaped.

32. The apparatus according to claim 31 wherein each clamp comprises a pair of movable arms, and wherein the open area extends between the movable arms.

33. The apparatus according to claim 32 and further comprising at least one surgical instrument, wherein each surgical instrument includes a first instrument arm and a second instrument arm, wherein the first and second instrument arms are operatively connected in relatively rotatable relation, and wherein at least one of the first and second instrument arms is in operative connection with a finger hole, and wherein the stringer rod extends through the finger hole.

34. The apparatus according to claim 33 wherein the first and second instrument arms terminate in respective first and second engageable tips, and wherein the stringer rod in engagement with the finger hole is operative to hold the first and second tips in separated relation.

35. A method comprising:
(a) engaging at least one clamp with at least one support of a surgical instrument stand, wherein the at least one support extends between a first end plate and a second end plate of the stand, wherein each support extends in an axial direction, wherein each clamp is selectively positioned in the axial direction between the end plates, and wherein the at least one clamp separates the at least one support into a first area and a second area; and
(b) engaging at least one surgical instrument with the at least one support in each of the first area and the second area, wherein each surgical instrument includes a first instrument arm and a second instrument arm operatively connected in rotatable relation, and wherein the includes engaging one of the first and second instrument arms of each surgical instrument with the at least one support.

36. The method according to claim 35 wherein (b) comprises engaging a first stringer including a plurality of surgical instruments with the at least one support in the first area and a second stringer comprising a plurality of surgical instruments with the at least one support in the second area.

37. The method according to claim 36 and further comprising:
(c) relatively moving the first end plate and a second end plate so as to change a length of the at least one support extending therebetween, wherein the at least one support includes a plurality of members, and wherein the members move in telescoping relation.

38. The method according to claim 37 wherein the at least one clamp includes an open area, and wherein at least some of the engaging instruments included in the first stringer and a second stringer include a finger hole,
and further comprising:
(d) extending a stringer rod through apertures in the first and second end plates, the open area of at least one clamp, and a finger hole of at least one surgical instrument.

39. The method according to claim 38 wherein at least some of the surgical instruments having a finger hole include engageable tips in operative connection with respective first and second instrument arms, and wherein in (d) the stringer rod is operative to hold the engageable tips in separated relation.

40. The method according to claim 39 and further comprising:
(e) subsequent to (d), sterilizing together in engaged relation the instrument stand, at least one clamp, and the first and second stringers.

41. The method according to claim 40 wherein the telescoping members of the at least one support include at least one fluid flow space, and wherein the at least one support includes at least one opening in fluid connection with the at least one fluid flow space,
and wherein (e) includes passing sterilizing fluid material into the at least one fluid flow space.

42. The method according to claim 40 wherein the at least one clamp includes a jaw, and wherein in cross section the jaw in engagement with the at least one support includes a plurality of flow spaces between the jaw and the at least one support, and wherein (e) includes passing fluid material into the plurality of flow spaces.

43. The method according to claim 40 and further comprising:
(f) subsequent to (e), placing together in engaged relation the instrument assembly, at least one clamp, the stringer rod and the first and second stringers in operatively supported connection with a sterile supporting surface in a surgical facility;
(g) removing the stringer rod from the apertures in the end plates, the open area of the at least one clamp, and the finger holes, whereby surgical instruments may be removed from operative engagement with the at least one support.
